(19) United States
(12) Patent Application Publication
(10) Pub. No.: US 2016/0162165 A1
(43) Pub. Date: Jun. 9, 2016

(54) VISUALIZATION ADAPTATION FOR FILTERED DATA

(71) Applicant: Harish Kumar Lingappa, Bangalore (IN)

(72) Inventor: Harish Kumar Lingappa, Bangalore (IN)

(21) Appl. No.: 14/559,641

(22) Filed: Dec. 3, 2014

(51) Int. Cl. G06F 3/0484; G06F 17/21; G06F 3/0482

(52) U.S. Cl. CPC G06F 3/04847; G06F 3/0482; G06F 3/04842; G06F 17/212

(57) ABSTRACT

Examples of data visualization adaptation to filtered data are provided herein. A visualization type of a data visualization can be changed to reflect filtering of the data represented by the visualization to provide a clear, useful representation of the filtered data. A first data visualization can be generated that represents data in a dataset. The first data visualization is of a first visualization type. Filter information for filtering the data in the dataset can be received. Based at least in part on the filter information, one or more alternative visualization types can be selected. A second data visualization can then be generated. The second data visualization represents data in a subset of the dataset corresponding to the filter information. The visualization type of the second data visualization is one of the alternative visualization types.

### BACKGROUND

As computer hardware and software become increasingly advanced, the amount of data collected about a variety of things has grown substantially. Analytics software has been increasingly used to analyze and interpret such large amounts of data. Visualization applications, for example, can provide graphical representations of different aspects of data to allow a user to easily understand complicated relationships. Visualization applications typically provide functionality to filter the data that is represented by a visualization in order to focus on different aspects of the data. Conventional visualization applications, however, typically present the filtered data using the same visualization type as the original data, which can result in potentially confusing or meaningless visualizations, as well as consuming unnecessary computing resources by forcing a user to create and generate a new visualization that is more useful.

### BRIEF DESCRIPTION OF THE DRAWINGS

FIG. 1 is an example visualization adaptation system.

FIG. 2 illustrates an example method for adapting a visualization to filtered data.

FIG. 3 is an example user interface of a visualization application in which a visualization can be adapted to filtered data, the user interface including an initial visualization is displayed.

FIG. 4 shows the user interface of FIG. 3 after filter information reducing the number of measures from four to two has been entered and a filter control has been interacted with, the user interface including selectable representations of alternative visualization types presented for user selection.

FIG. 5 shows the user interface of FIG. 4 after an alternative visualization type has been selected, the user interface including an updated visualization of the alternative visualization type.

FIG. 6 shows the user interface of FIG. 3 after filter information has been entered reducing the number of dimensions from five to one and a filter control has been interacted with, the user interface including selectable representations of alternative visualization types presented for user selection.

FIG. 7 shows the user interface of FIG. 6 after an alternative visualization type has been selected, the user interface including an updated visualization of the alternative visualization type.

FIG. 8 illustrates an example method for adapting a visualization to filtered data in which selectable representations of alternative data visualization types are provided for display.

FIG. 9 is a diagram illustrating a generalized implementation environment in which some described examples can be implemented.

### DETAILED DESCRIPTION

The examples described herein generally allow adaptation of data visualizations based on filtered data. Data visualizations provide easy-to-understand, graphical representations of data that are useful for data analysis. In typical conventional data visualization applications, when a user filters the data represented in a visualization, the amount of data represented in the visualization is reduced according to the filtering, but the visualization type of the visualization remains unchanged. The resulting data visualization of the filtered data is often confusing or simply not useful.

In the described examples, when a user filters data represented by a data visualization, alternative data visualization types are identified that are appropriate for the filtered data. For example, a somewhat complex visualization type such as a stacked column chart can be used to represent data for multiple dimensions and multiple measures. If a filter is applied to filter down either the dimensions or measures to a single dimension or measure, a stacked column chart or other complicated chart is likely no longer helpful, and other visualization types are likely more appropriate and useful (e.g. a pie chart, a donut chart, a column chart, etc.).

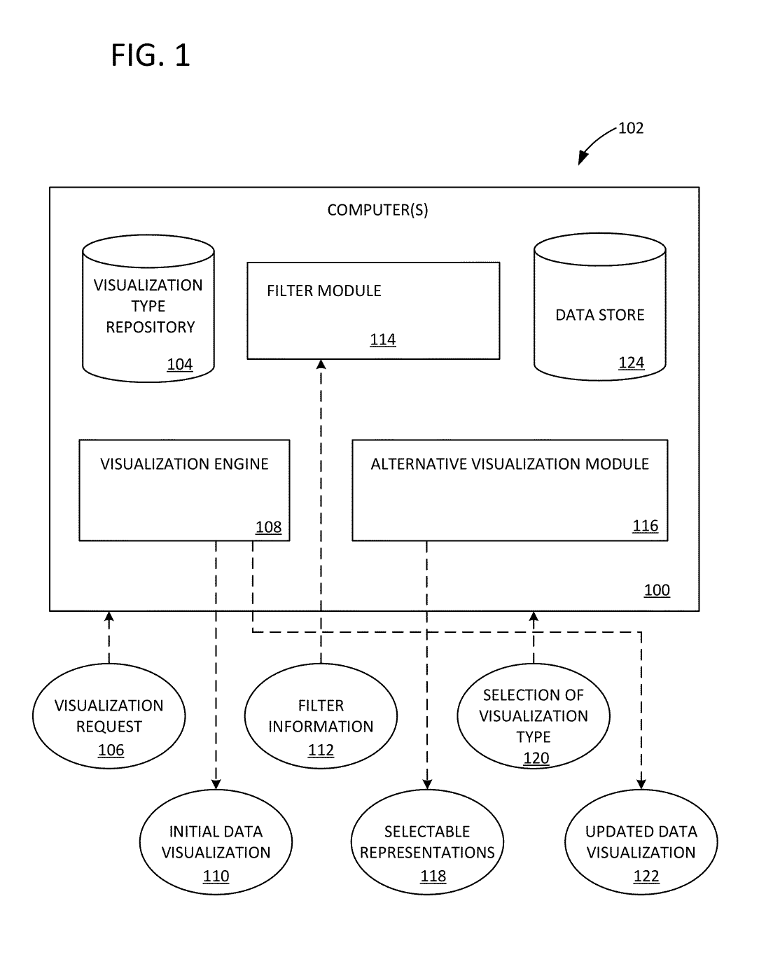

Representations of the alternative visualization types can be presented to a user for selection. A data visualization representing the filtered data and having the selected alternative visualization type can then be generated. In this way, filtered data can be presented in a more usable and understandable manner without a requiring a user to waste the time and computing resources associated with starting the visualization process anew to generate a similar alternative visualization. Examples are described below with reference to FIGS. 1-9.

FIG. 1 illustrates one or more computer(s) 100 implementing a visualization adaptation system 102. System 102 includes a visualization type repository 104 that stores a plurality of data visualization types. A data visualization is a graphical representation of data, such as a chart, graph, or table. The plurality of data visualization types can include, for example, a stacked column chart, a column chart, a three-dimensional column chart, a line chart, an area chart, a table, a pie chart, a donut chart, or other visualization types. In response to a data visualization request 106, a visualization engine 108 generates an initial data visualization 110 that represents initial data selected for display. Visualization request 106 can be specified by a user through a data visualization application or other software application having data visualization functionality. Such applications can be web applications provided over the Internet or can be installed on local computers or server computers accessible over a local area network (LAN) or other network. In some examples, visualization engine 108 and other components of system 102 are part of a data visualization application.

Initial data visualization 110 is of a first visualization type. In some examples, visualization engine 108 automatically selects the first visualization type based on characteristics of the data that is represented by the visualization. For example, the number of measures and dimensions of the data can be used to determine the initial visualization type. In other examples, a user selects the initial visualization type. The terms “measures” and “dimensions” are well-known in analytics. As an example, in a visualization depicting population by city, the cities (x-axis) are dimensions and population (y-axis) is a measure. Dimensions used in this context does not refer to a geometric dimension such as a measurement of height, width, or length, or a state of being one-dimensional, two-dimensional (2D), or three-dimensional (3D).

Filter information 112 is provided, for example, by a user. Filter information 112 specifies how a dataset is to be filtered. In some examples, filter information 112 can include measures and/or dimensions to add or remove from the dataset represented in initial data visualization 110. The examples discussed herein primarily refer to “filtering” in the context of reducing the amount of data that is represented by a visualization, but it is also contemplated that filter information 112 can increase the amount of data (e.g., by adding a measure or dimension to a visualization). A filter module 114 determines updated data for display based at least in part on received filter information 112.

Alternative visualization module 116 identifies a plurality of alternative visualization types based at least in part on at least one of the updated data for display determined by filter module 114 or the received filter information 112. The plurality of alternative visualization types can be, for example, selected from the alternative visualization types stored in visualization type repository 104. The plurality of alternative visualization types can be identified based at least in part on a changed number of measures or dimensions of the updated data selected for display as compared to the initial data selected for display. Various algorithms can be used to identify alternative visualization types that are appropriate for displaying filtered data.

In some examples, users can select particular visualization types as preferred alternative visualization types for particular circumstances (e.g., for particular numbers of measures and/or dimensions). For example, a user can specify that a pie chart is to be used or included as an alternative visualization type when filter information 112 indicates that a single measure or a single dimension is specified. In some examples, one or more preferred alternative visualization types are included in the plurality of alternative visualization types, but other alternative visualization types are also identified through other methods. In some examples, a user can specify one or more visualization types to include in the plurality of alternative visualization types regardless of the characteristics of filter information 112. In other examples, preferred alternative visualizations are included in the plurality of alternative visualization types when the preferred alternative visualizations are appropriate based on the characteristics (e.g. number of measures and/or dimensions) specified in filter information 112.

In some examples, visualization types can be categorized or grouped by the number of measures and dimensions for which they are useful or appropriate. For example, visualization types appropriate for multiple measures and multiple dimensions can include one or more of: a stacked column chart, a column chart, a three-dimensional column chart, a line chart, an area chart, or a table. Example visualization types appropriate for a single measure or a single dimension can include one or more of: a column chart, a three-dimensional column chart, a line chart, an area chart, a table, a pie chart, or a donut chart. Some visualization types (such as a column chart, a line chart, and a table) can be appropriate and useful for data having different numbers of measures and dimensions. Other visualization types (such as a pie chart or a donut chart) are more appropriate and useful for data having either a single measure or a single dimension.

In some examples, certain alternative visualization types are identified regardless of the received filter information 112. For example, the identified plurality of alternative visualization types can include a table and/or the same visualization type as initial data visualization 110 regardless of received filter information 112. Alternative visualization module 116 can also identify alternative visualization type(s) that have a same number of geometric dimensions as the first visualization type. For example, if initial data visualization 110 is a 3D visualization, this may indicate that the user prefers 3D visualizations, so at least some of the identified alternative visualizations can also be 3D visualizations.

In some examples, alternative visualization module 116 generates selectable representations 118 of at least some of the plurality of alternative visualization types. Selectable representations 118 can be, for example, a graphical representation and/or a text description. Selectable representations 118 can be presented within at least one of a list box, drop-down menu, or pop-up window. In various examples, different numbers of representations are included in selectable representations 118 (e.g. two representations, three representations, five representations, etc.). In other examples, one of the plurality of alternative visualization types is automatically selected based on indicated user preferences, machine learning from previous user selections, or other methods.

A selection 120 of one of the selectable representations 118 instructs visualization engine 108 to generate an updated data visualization 122 representing the updated data for display. Updated data visualization 122 is of the alternative visualization type of the selected selectable representation. Alternative visualization module 116 can generate the selectable representations upon receiving an indication of a user interaction with at least one of initial data visualization 110 or a filter control. The user interaction can be a selection, hover, right-click, double-click, touch, touch-and-hold, or other interaction.

Data store 124 stores data represented by initial data visualization 110 and updated data visualization 122. Data store 124 can be a database, such as an in-memory columnar relational database, and can be located, in some examples, external to computer(s) 100.

In FIG. 1, the arrows indicating inputs and outputs of system 102 are only an example. Any of the components of system 102 can be in communication with any other components. In examples in which system 102 is implemented on multiple computer(s) 100 (e.g. multiple server computers), computers 100 can be in communication via a network (not shown). The network can be the Internet, a LAN, a wireless local area network (WLAN), a wide area network (WAN), or other type of network, wired or wireless. Visualization request 106, filter information 112 and selection of visualization type 120 can be received via the network, and initial data visualization 110, selectable representations 118, and updated data visualization 122 can be provided via the network.

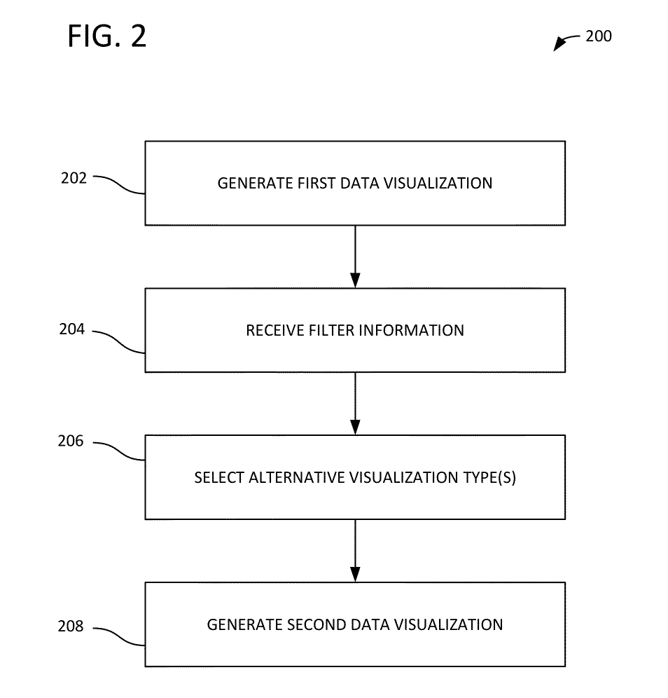

FIG. 2 illustrates a method 200 of adapting a visualization to filtered data. In process block 202, a first data visualization is generated. The first data visualization represents data in a dataset and is of a first visualization type. In process block 204, filter information for filtering the data in the dataset is received. Based at least in part on the filter information, in process block 206, at least one alternative visualization type is selected. In process block 208, a second data visualization is generated. The second data visualization represents data in a subset of the dataset corresponding to the filter information and is of one of the at least one alternative visualization types. Method 200 can also comprise presenting the second data visualization in place of the first data visualization.

In some examples, method 200 further comprises, prior to generating the second data visualization: presenting selectable representations of respective visualization types of the at least one alternative visualization type; and receiving an indication that the alternative visualization type of the second data visualization has been selected. The selectable representations of respective visualization types can be presented upon receiving an indication of a user interaction with a filter control, such as a filter button. In some examples, the selectable representations of respective visualization types are presented in association with the filter control. For example, the selectable representations can be presented adjacent to, overlapping, or near the filter control. The selectable representations of respective visualization types can be presented in at least one of a list box, drop-down menu, or pop-up window. Other presentation formats are also possible. The selectable representations of respective visualization types can also be presented upon receiving an indication of a user interaction with the first visualization (e.g., a right-click on, touch-and-hold on, or hover over the first visualization).

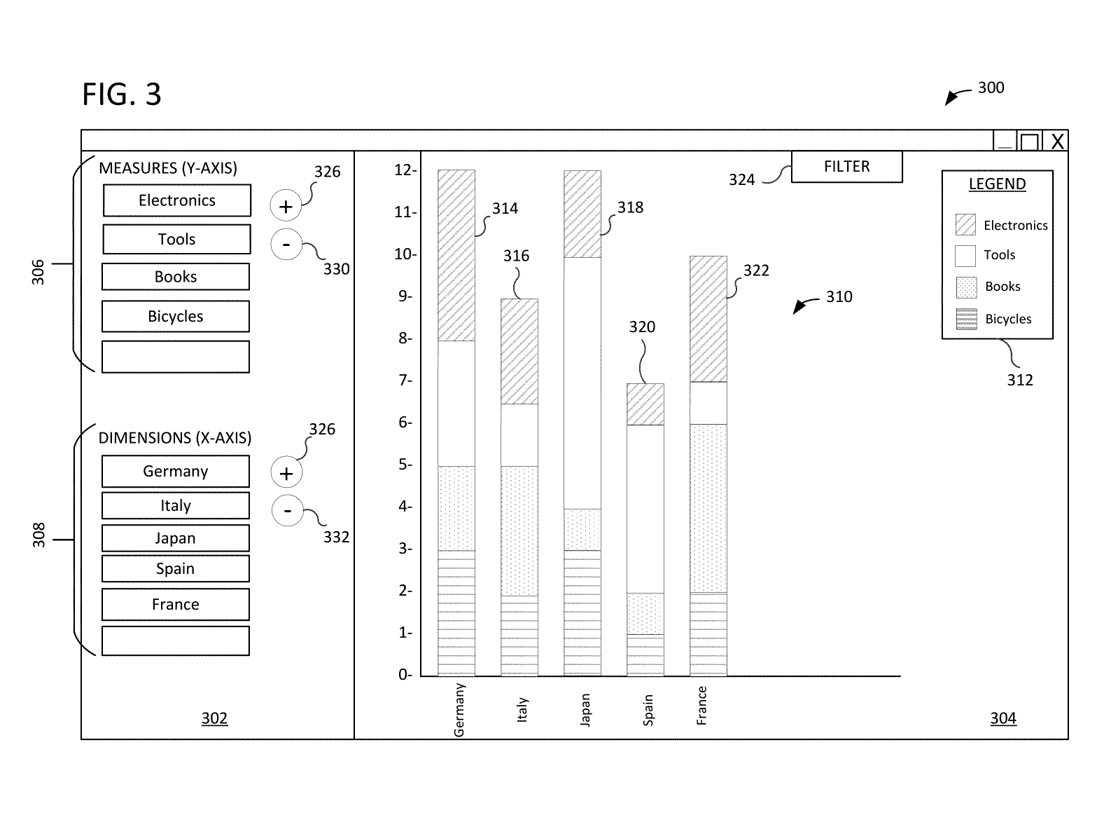

FIG. 3 illustrates an example user interface 300 of an application. Interface 300 includes a data selection area 302 and a data visualization display area 304. Data selection area 302 includes a group of measures 306 and a group of dimensions 308. Group of measures 306 includes “electronics,” “tools,” “books,” and “bicycles.” Group of dimensions 308 includes “Germany,” “Italy,” “Japan,” “Spain,” and “France.” The measures included in group of measures 306 and the dimensions included in group of dimensions 308 can, for example, be selected by a user in order to create an initial data visualization 310.

Initial data visualization 310 is displayed in data visualization display area 304, along with a legend 312 corresponding to the measures shown in group of measures 306. Initial data visualization 310 is a stacked column chart in which each of the four measures in group of measures 306 are represented for each corresponding dimension as a portion of a single column For example, column 314 illustrates the quantities of the measures for Germany, showing 3 units for bicycles, 2 units for books, 3 units for tools, and five units for electronics. Columns 316, 318, 320, and 322 similarly illustrate the measures for Italy, Japan, Spain, and France, respectively.

Filter control 324 allows a user to filter the measures in group of measures 306 and/or the dimensions in group of dimensions 308 that are represented by initial data visualization 310. In some examples, a user can filter data through use of add buttons 326 and 328 or remove buttons 330 and 332. For example, to add a measure, the user can enter or select an additional measure into box 334 and then select add button 326. Similarly, to remove a dimension, a user can select a dimension from group of dimensions 308 and select remove button 332. To execute the filter, the user can then select filter control 324. In some examples, filter control 324 is selected first, and then either data selection area 302 or another interface are presented for filter parameters to be specified. Various other interfaces for specifying how data is to be filtered are also contemplated.

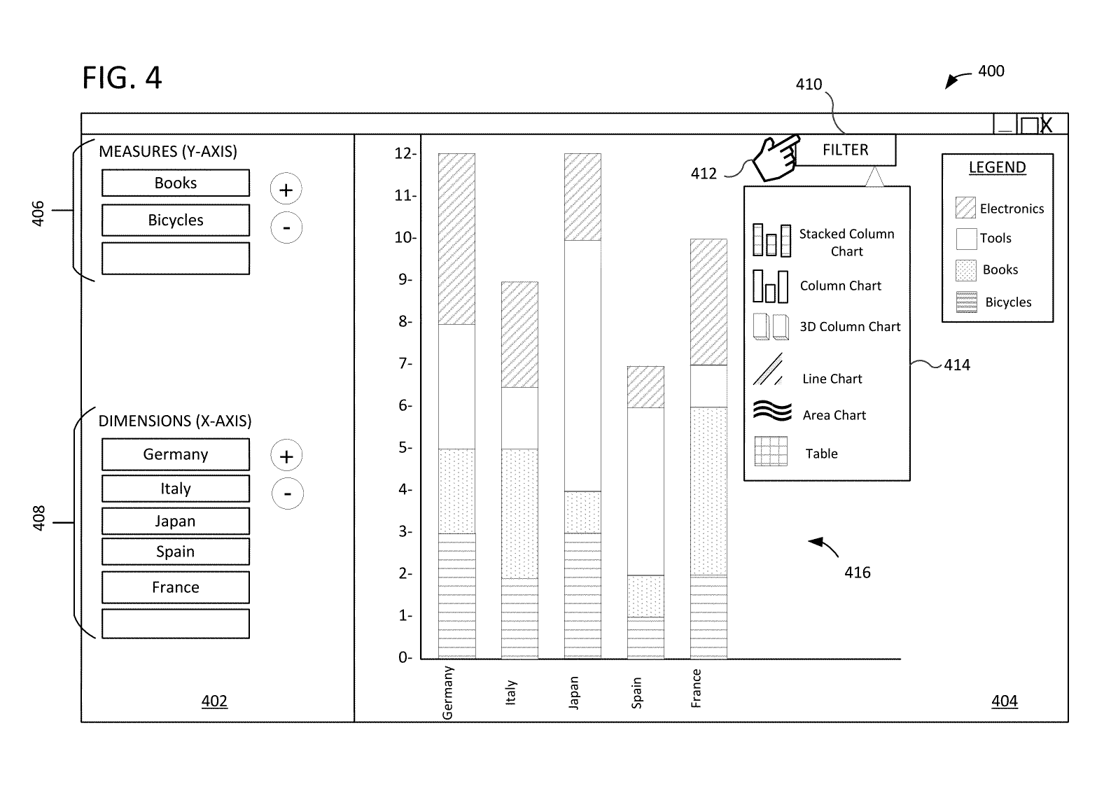

In some examples, filtering is accomplished through interacting with initial visualization 310 or other aspect of interface 300 such as legend 312 rather than a dedicated filter control such as filter control 324. In some examples, a user can select measures to remove from the visualization by selecting the corresponding portion of legend 312. In some examples, a user can right-click, touch, hover, touch-and-hold, or otherwise interact with initial data visualization 310 to either generate an input interface for specifying filter parameters or to execute a filter as specified by modifications to group of measures 306 and/or group of dimensions 308 in data display area 302. In some examples, interaction with filter control 324 or with initial data visualization 310 causes identification of alternative visualization types and generation of selectable representations of alternative visualization types. This is illustrated in FIG. 4.

FIG. 4 illustrates user interface 400, which is similar to the user interface 300 of FIG. 3 with additional aspects visible during the filtering process. Interface 400 includes a data selection area 402 and a data visualization display area 404. Group of measures 406 includes two measures, books and bicycles, illustrating a filtering removal of tools and electronics from group of measures 306 of FIG. 3. Group of dimensions 408 is the same as group of dimensions 306 in FIG. 3.

In FIG. 4, after tools and electronics have been removed as measures, a user interacts with filter control 410, the interaction represented by pointer icon 412. Based on filter information (i.e., the removal of tools and electronics as measures), alternative visualization types are identified, and selectable representations of the alternative visualization types are generated and presented in a list box 414 in association with filter control 410. The alternative visualization types can be identified through application of one or more algorithms, through specified user preferences, through machine learning based on previous user selections, or by identifying the number of measures and/or dimensions specified and identifying corresponding visualization types categorized by number of measures and/or dimensions.

The respective selectable representations in list box 414 include both an icon illustrating the alternative visualization type as well as a corresponding text description. In some examples, either the graphical representation (icon) or text description are omitted. The selectable representations can also be presented in a drop-down menu, pop-up window, or other format, and can be presented in another location within interface 400. In some examples, the current visualization type (the visualization type of initial data visualization 416) is included in list box 414 regardless of whether the current visualization type is identified as an alternative. This helps ensure that if the user would prefer to continue viewing data using the same visualization type after filtering, even if other visualization types would be more appropriate or useful, that the user has the option to do so. Other visualization types can also be included regardless of filtering information. For example, users may frequently find that a table, column chart, or line chart is a useful visualization type regardless of the number of measures and dimensions.

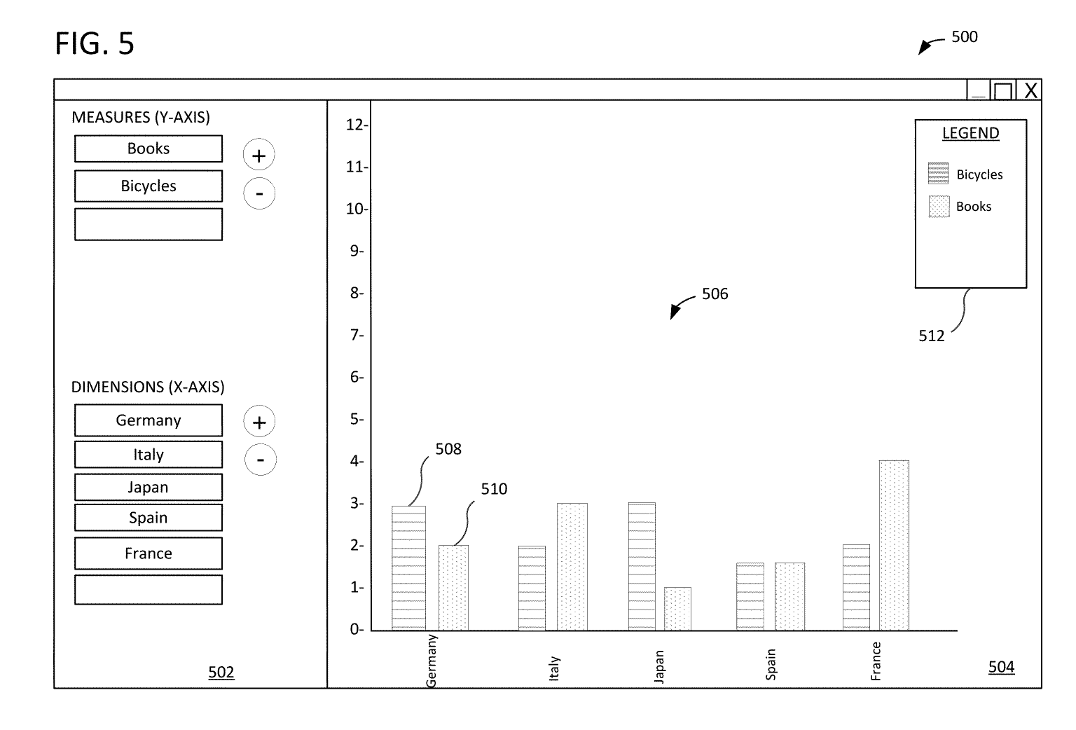

FIG. 5 illustrates a user interface 500 that is displayed upon receiving an indication of a user selection of one of the alternative visualization types included in list box 414 in FIG. 4. Interface 500 includes data selection area 502, which is unchanged over data selection area 402 of FIG. 4 and reflects the reduced number of measures. In data visualization display area 504, updated data visualization 506 has the alternative visualization type of the representation selected by the user from list box 414 in FIG. 4—a column chart. Updated data visualization 506 shows a column for each measure for each dimension. Thus, for the dimension Germany, column 508 represents bicycles, and column 510 represents books. Legend 512 has been updated to reflect the reduced number of measures. Updated data visualization 506 provides a more useful illustration of the number of books and bicycles than if the initial visualization type (stacked column chart) had been retained after the filtering.

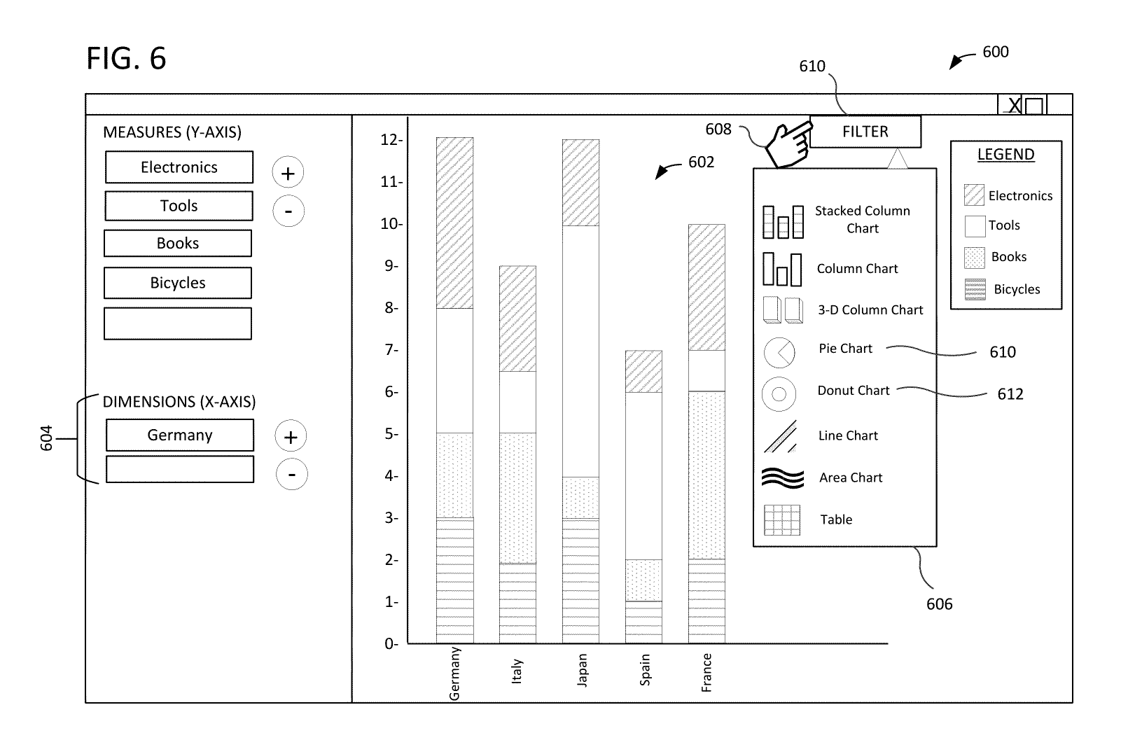

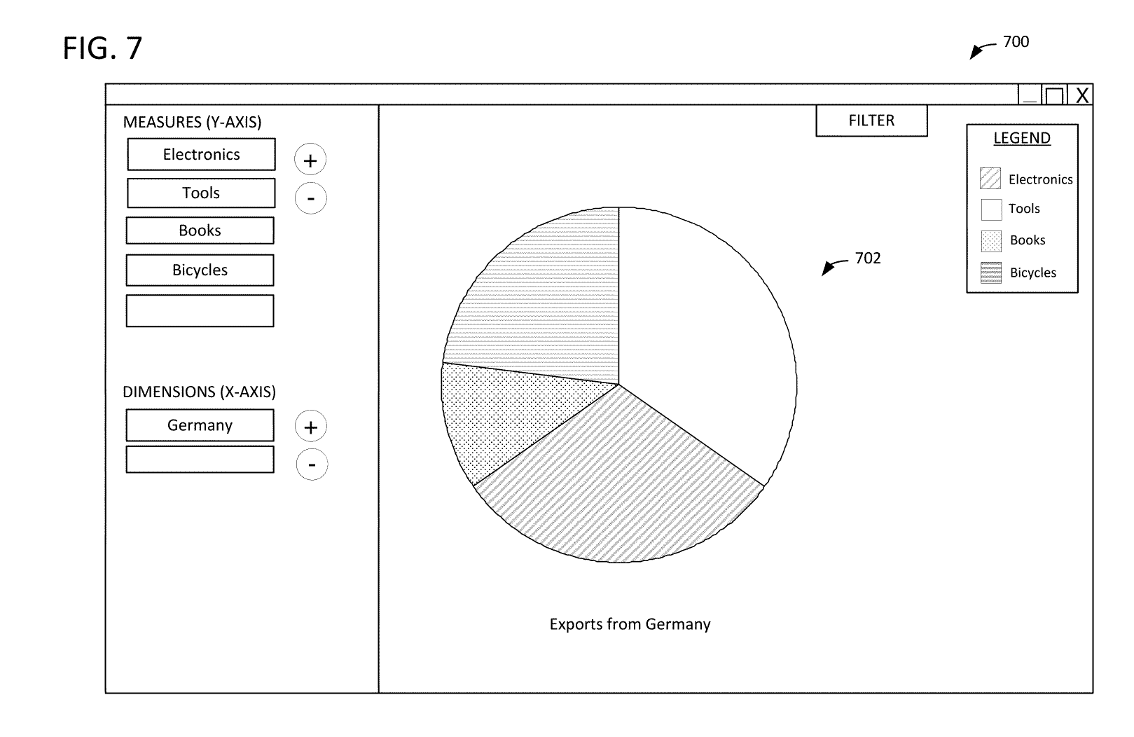

FIGS. 6 and 7 illustrate another example of filtering data and selecting one of a group of presented alternative visualization types for the updated data visualization. FIG. 6 illustrates an interface 600 similar to interface 300 of FIG. 3. In interface 600, initial data visualization 602 is the same as in FIG. 3, but the number of dimensions and measures specified for filtering is different. In interface 600, group of dimensions 604 includes one dimension, Germany, where group of dimensions 308 of FIG. 3 included five dimensions. List box 606 of alternative visualization types is generated and presented upon user interaction (represented by pointer icon 608) with filter control 610. Because the number of measures displayed has been reduced to a single measure, list box 606 contains, among others, representations of two alternative visualization types, pie chart 612 and donut chart 614, that are appropriate for a single measure or dimension but are less useful for multiple measures and multiple dimensions.

FIG. 7 illustrates a user interface 700 illustrating what is displayed after selection of one of the alternative visualization types from list box 606 in FIG. 6. Updated data visualization 702 is a pie chart, the alternative visualization type selected by a user from list box 606 in FIG. 6. For a single dimension (Germany), the pie chart provides a clear illustration of the respective measures (electronics, tools, books, bicycles). By identifying alternative visualization types that are appropriate for filtered data and presenting selectable representations of the alternative visualization types, the user is given a simple and efficient way to ensure that an updated data visualization presents clear and meaningful information.

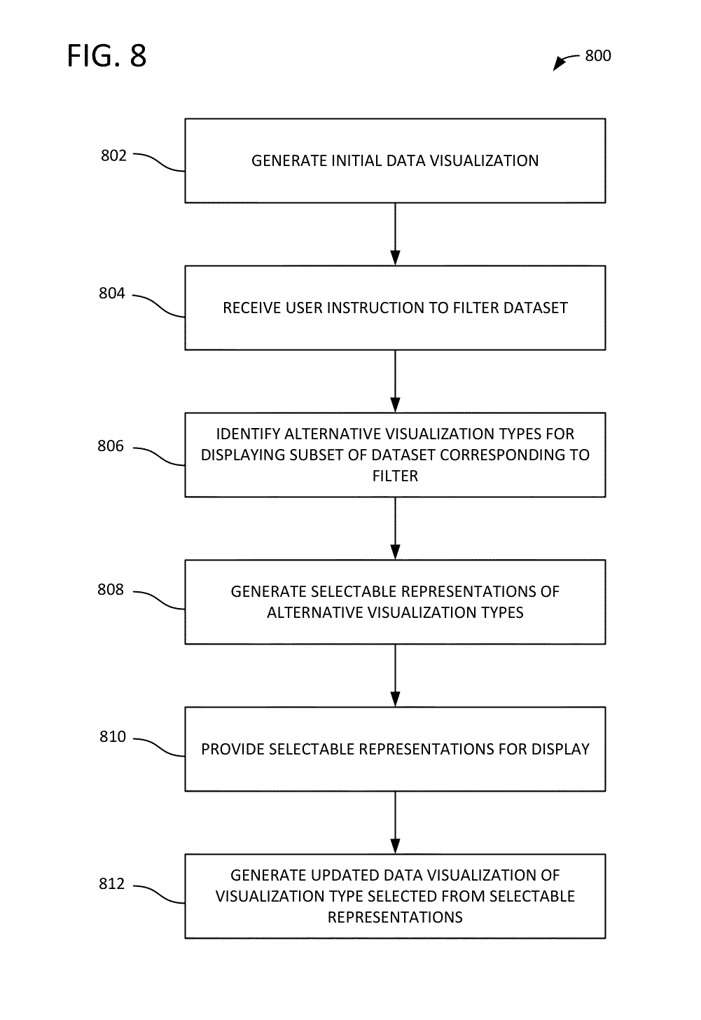

FIG. 8 illustrates an example method 800 of adapting a visualization to filtered data. In process block 802, an initial data visualization is generated. The initial data visualization represents data in a dataset and is of an initial visualization type. In process block 804, a user instruction is received to filter the data in the dataset based on values for one or more filter parameters. The filter parameters can comprise measures and dimensions, and the user instruction to filter the data can specify a reduced number of measures and/or dimensions.

In response to the user instruction, a plurality of alternative visualization types are identified in process block 806 for displaying a subset of the data in the dataset corresponding to the values for the one or more filter parameters. In process block 808, selectable representations are generated of the respective alternative visualization types of the plurality of alternative visualization types. In process block 810, the selectable representations are provided for display in association with at least one of a filter control or the initial data visualization. Upon receiving an indication of a user selection of one of the plurality of alternative visualization types, an updated data visualization of the selected alternative visualization type is generated in process block 812. The updated data visualization represents the subset of the data in the dataset.

### Examples of Computing Environments

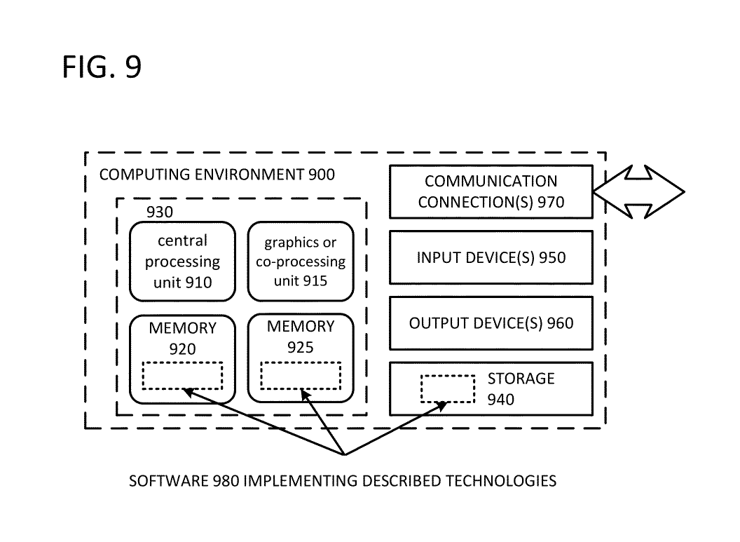

FIG. 9 depicts a generalized example of a suitable computing environment 900 in which the described innovations may be implemented. The computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, media player, gaming system, mobile device, etc.)

With reference to FIG. 9, the computing environment 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power.

For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s). For example, memory 920 and 925 and software 980 can store computer-executable instructions for adapting visualizations to filtered data. Computing environment 900 can include visualization engine 108, filter module 114, and alternative visualization module 116 of FIG. 1.

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. For video encoding, the input device(s) 950 may be a camera, video card, TV tuner card, or similar device that accepts video input in analog or digital form, or a CD-ROM or CD-RW that reads video samples into the computing environment 900. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

What is claimed is:

1. One or more computer-readable storage media storing instructions that, when executed by a computing device, perform a method of adapting a visualization to filtered data, the method comprising:
generating a first data visualization, the first data visualization representing data in a dataset and being of a first visualization type;
receiving filter information for filtering the data in the dataset;
based at least in part on the filter information, selecting at least one alternative visualization type; and
generating a second data visualization, the second data visualization representing data in a subset of the dataset corresponding to the filter information and being of one of the at least one alternative visualization type.

2. The computer-readable storage media of claim 1, wherein the method further comprises:
prior to generating the second data visualization:
presenting selectable representations of respective visualization types of the at least one alternative visualization type; and
receiving an indication that the alternative visualization type of the second data visualization has been selected.

3. The computer-readable storage media of claim 2, wherein the selectable representations of respective visualization types are presented upon receiving an indication of a user interaction with a filter control.

4. The computer-readable storage media of claim 3, wherein the selectable representations of respective visualization types are presented in association with the filter control.

5. The computer-readable storage media of claim 2, wherein the selectable representations of respective visualization types are presented in at least one of a list box, drop-down menu, or pop-up window.

6. The computer-readable storage media of claim 2, wherein the respective visualization types include at least one of the first visualization type or a table.

7. The computer-readable storage media of claim 2, wherein the selectable representations of respective visualization types are presented upon receiving an indication of a user interaction with the first visualization.

8. The computer-readable storage media of claim 1, wherein the first visualization type comprises at least one of: a stacked column chart, a column chart, a three-dimensional column chart, a line chart, an area chart, a table, a pie chart, or a donut chart.

9. The computer-readable storage media of claim 1, wherein the selecting at least one alternative visualization type is accomplished through at least one of: application of one or more algorithms, application of specified user preferences, machine learning based on previous user selections, or by identifying a number of measures and/or dimensions specified and identifying corresponding visualization types categorized by number of measures and/or dimensions.

10. The computer-readable media of claim 1, wherein the at least one alternative visualization type has a same number of geometric dimensions as the first visualization type.

11. The computer-readable media of claim 1, wherein the first data visualization is a plot of dimensions versus measures, and wherein the second data visualization represents at least one of fewer dimensions or fewer measures.

12. The computer-readable media of claim 11, wherein the second data visualization represents at least one of a single measure and multiple dimensions or a single dimension and multiple measures, and wherein the second data visualization is one of a pie chart, a donut chart, a line chart, and area chart, a column chart, a three-dimensional column chart, or a table.

13. One or more computers implementing a visualization adaptation system, the system comprising:
a visualization type repository that stores a plurality of data visualization types;
a visualization engine that generates an initial data visualization that represents initial data selected for display;
a filter module that determines updated data for display based at least in part on received filter information; and
an alternative visualization module that:
identifies, based at least in part on at least one of the updated data for display or the received filter information, a plurality of alternative visualization types from the plurality of data visualization types stored in the visualization type repository; and
generates selectable representations of at least some of the plurality of alternative visualization types, wherein a selection of one of the selectable representations instructs the visualization engine to generate an updated data visualization representing the updated data for display, the updated data visualization being of the alternative visualization type of the selected selectable representation.

14. The one or more computers of claim 13, wherein the plurality of alternative visualization types are identified based at least in part on a changed number of measures or dimensions of the updated data selected for display as compared to the initial data selected for display.

15. The one or more computers of claim 13, wherein the at least some of the plurality of alternative visualization types of which the plurality of selectable representations are generated comprises a visualization type of the initial visualization, a table, and at least one additional alternative visualization type.

16. The one or more computers of claim 13, wherein the alternative visualization module generates the selectable representations upon receiving an indication of a user interaction with at least one of the initial data visualization or a filter control.

17. A computer-implemented method of adapting a visualization to filtered data, the method comprising:
generating an initial data visualization, the initial data visualization representing data in a dataset and being of an initial visualization type;
receiving a user instruction to filter the data in the dataset based on values for one or more filter parameters;
in response to the user instruction, identifying a plurality of alternative visualization types for displaying a subset of the data in the dataset corresponding to the values for the one or more filter parameters;
generating selectable representations of the respective alternative visualization types of the plurality of alternative visualization types;
providing the selectable representations for display in association with at least one of a filter control or the initial data visualization; and
upon receiving an indication of a user selection of one of the plurality of alternative visualization types, generating an updated data visualization of the selected alternative visualization type, the updated data visualization representing the subset of the data in the dataset.

18. The computer-implemented method of claim 17, wherein the one or more filter parameters comprise measures and dimensions, and wherein the user instruction to filter the data specifies a reduced number of measures and/or dimensions.

19. The computer-implemented method of claim 17, wherein the initial data visualization represents multiple measures and multiple dimensions, wherein the updated data visualization represents at least one of a single measure and multiple dimensions or a single dimension and multiple measures, and wherein the updated data visualization is one of a pie chart, a donut chart, a line chart, and area chart, a column chart, a three-dimensional column chart, or a table.

20. The computer-implemented method of claim 17, wherein the selectable representations comprise at least one of a graphical representation or a text description, and wherein the selectable representations are contained within at least one of a list box, drop-down menu, or pop-up window.
